(19) United States
(12) Patent Application Publication
(10) Pub. No.: US 2026/0203119 A1
(43) Pub. Date: Jul. 16, 2026

(54) PROACTIVE APPROACH TO WORKLOAD PERFORMANCE AND OPERATION

(71) Applicant: Dell Products L.P., Round Rock, TX (US)

(72) Inventors: ERIC RANDAL YOUNG, Alexandria, VA (US); TAMILARASAN JANAKIRAMAN, Cork (IE); CHARU LATA OJHA, Cork (IE)

(21) Appl. No.: 19/025,819

(22) Filed: Jan. 16, 2025

(51) Int. Cl. G06F 9/50; G06F 9/48

(52) U.S. Cl. CPC G06F 9/5027; G06F 9/4881; G06F 9/5088; G06F 2209/5019

(57) ABSTRACT

Methods and systems for managing operation of a deployment to facilitate completion of workloads are disclosed. The operation may be managed by performing a management operation to optimize at least an efficiency, at least a reliability, etc. of the operation of the deployment. The management operation may be selected based on a predicted future state of the deployment. The predicted future state may be obtained by ingesting, by a trained machine learning model, at least a current state of the deployment and/or generating the predicted future. The current state may include information that includes telemetry data, (ii) historical performance metrics, affinity rules, at least one occurrence and/or at least one projection of an alert, failure, and/or fault of the deployment, etc.

### A PROACTIVE APPROACH TO WORKLOAD PERFORMANCE AND OPERATION

### FIELD

Embodiments disclosed herein relate generally to managing operation of a deployment to facilitate completion of workloads. More particularly, embodiments disclosed herein relate to using a predicted future state of the deployment to optimize performance of the operation of the deployment.

### BACKGROUND

Computing devices may provide computer-implemented services. The computer- implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to "one embodiment" or "an embodiment" means that a particular feature, structure, or characteristic described in conjunction with the embodiment can be included in at least one embodiment. The appearances of the phrases "in one embodiment" and "an embodiment" in various places in the specification do not necessarily all refer to the same embodiment.

References to an "operable connection" or "operably connected" means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment to facilitate completion of workloads. The operation may be managed by performing a management operation to optimize at least an efficiency, at least a reliability, etc. of the operation of the deployment.

The management operation may be selected based on a predicted future state of the deployment. The management operation may be selected by (i) ingesting at least, by a scheduler of the deployment, the predicted future state and/or (ii) determining, by the scheduler, the management operation that improves the at least the efficiency, the at least the reliability, etc. of the deployment.

The predicted future state may be obtained by (i) ingesting, by a trained machine learning model, at least a current state of the deployment and/or (ii) generating the predicted future. The at least the current state may include information regarding the current state.

The information may include (i) workload telemetry data for historical workloads performed by the deployment, (ii) device telemetry data for data processing systems of the deployment, (iii) cost telemetry data for cost incurred for use of the deployment by a user, (iv) historical performance metrics, (v) affinity rules of the deployment, (vi) at least one occurrence and/or at least one projection of an alert, failure, and/or fault of the deployment, etc. The trained machine learning model may include training that recorded at least one relationship of the information.

In an embodiment, a method for managing operation of a deployment to facilitate completion of workloads is disclosed. The method may include: (i) obtaining a data package comprising information regarding a current state of the deployment, (ii) generating, using the data package and a trained machine learning model, a prediction regarding a future state of the deployment, the trained machine learning model being based, at least in part, on historical workload affinity rules and historical usage patterns, (iii) selecting a management operation for the deployment based on, at least, the future state of the deployment, and (iv) performing the management operation to update the operation of the deployment to facilitate continued completion of the workloads.

The information may include (i) workload telemetry data for historical workloads performed by the deployment, (ii) device telemetry data for data processing systems of the deployment, and (iii) cost telemetry data for cost incurred for use of the deployment by a user.

The workload telemetry data may indicate resource consumption costs, time to completion, and workload requests for the historical workloads. The cost telemetry data may indicate financial cost for completion of the historical workloads.

The device telemetry data may indicate, for the data processing systems, computing resource availabilities over time.

The management operation is one selected from a list of management operations consisting of (i) scheduling of performance of a new workload by a portion of the deployment, (ii) reallocating resources of the deployment ahead of a resource limiting event that is predicted to impact the deployment, and (iii) migrating an existing workload hosted by the first portion of the deployment to a second portion of the deployment.

The trained machine learning model may be also based on, at least in part, historical performance metrics of operation of the deployment, historical events impacting the deployment, and historical computing resource usage by the deployment.

The trained machine learning model may be based on a training data set comprising the historical performance metrics of the operation of the deployment, the historical events impacting the deployment, the historical computing resource usage by the deployment, historical workload affinity rules, and historical usage patterns.

The training data set may further include historical computing resource consumption for operation of management frameworks hosted by the deployment, the management frameworks facilitate deployment and operation of containerized workloads.

The deployment may include data processing systems that host instances of the management frameworks, the management frameworks being adapted to deploy and manage operation of containers that perform the containerized workloads.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer- implemented method when the computer instructions are executed by the processor.

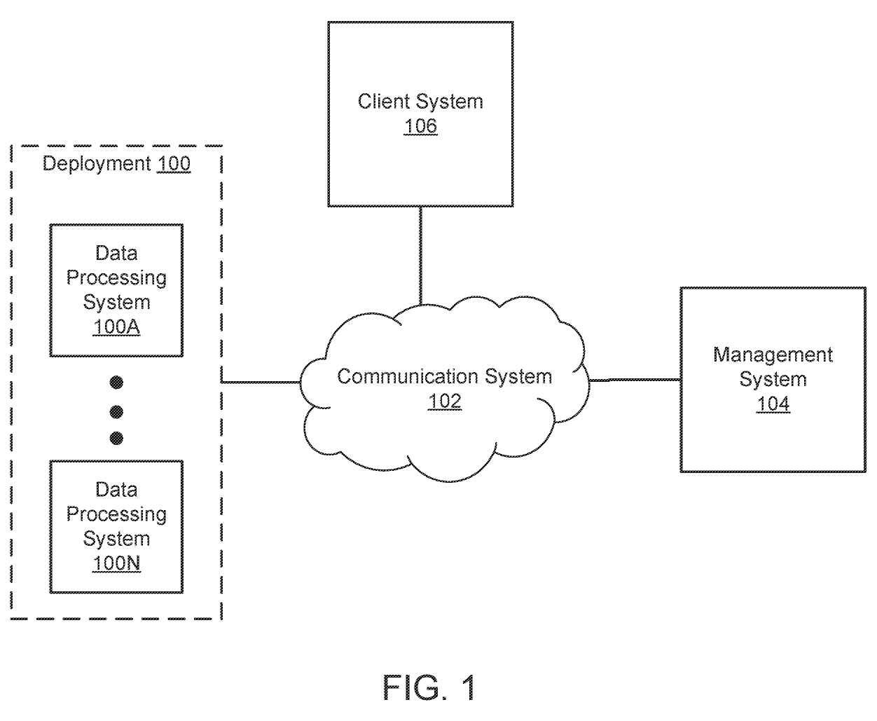

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, a workload may be performed in a deployment. The workload may include (i) hosting a web application, (ii) training a machine learning model, (iii) performing a scientific simulation (e.g., climate modeling, bioinformatics, etc.), etc. The workload may be performed by allocating at least one task of the workload to a container of the deployment and/or performing, by an application of the container, the at least one task of the workload. The container may include a deployable unit of software that further includes the application and/or dependencies of the application.

However, in the performance of the workload, at least one obstacle may arise. The at least one obstacle may include (i) a resource allocation inefficiency, (ii) a performance bottleneck, (iii) a suboptimal utilization of at least one affinity rule, etc. The at least one obstacle may arise by underestimating, by a scheduler, at least one resource requirement of the deployment. The scheduler may assign the workload to available resources of the deployment. The scheduler may also distribute containers across the deployment based on (i) resource availability, (ii) the at least one affinity rule, (iii) a resource need of the workload, etc. As a result of the at least one obstacle, a provision of computer implemented services may be impacted.

In general, embodiments disclosed here relate to systems and methods for managing operation of a deployment to facilitate completion of workloads. The operation may be managed by (i) obtaining a data package comprising information regarding a current state of the deployment, (ii) generating, using the data package and a trained machine learning model, a prediction regarding a future state of the deployment, the trained machine learning model being based, at least in part, on historical workload affinity rules and historical usage patterns, (iii) selecting a management operation for the deployment based on, at least, the future state of the deployment, and (iv) performing the management operation to update the operation of the deployment to facilitate continued completion of the workloads.

The data package may be obtained by receiving, by a scheduler of the deployment, the data package. The data package may be transmitted to the scheduler from, for example, an administrator of the deployment, a monitoring tool, etc. The data package may include telemetry data and/or historical workload metrics. The telemetry data may include (i) workload telemetry data for historical workloads performed by the deployment, (ii) device telemetry data for data processing systems of the deployment, (iii) cost telemetry data for cost incurred for use of the deployment by a user, etc. The workload telemetry data may include (i) resource consumption costs, (ii) time to completion of a workload, and/or (iii) workload requests for the historical workloads. The device telemetry data may include computing resource availabilities over time. The computing resource availabilities may include at least one current status and/or at least one measure of usage of central processing unit (CPU) cores, memory, network bandwidth, etc. The cost telemetry data may include financial costs for completion of the historical workloads. The financial costs may include charges related to a provision of services (e.g., computing instances, storage, data transfer, etc.) that are passed to a client.

The historical workload metrics may include (i) historical performance metrics of the deployment, (ii) historical events impacting the deployment, (iii) historical computing resource usage by the deployment, (iv) historical computing resource consumption for operation of management frameworks (i.e. which facilitate the deployment of a container for performance of a workload) hosted by the deployment, etc. The historical performance metrics may include (i) disk input/output (I/O) (e.g., a number of read and/or write operation performed, I/O operations per second, etc.), (ii) network througₕput (e.g., an average bandwidth usage, a peak bandwidth usage, etc.), etc. The historical events may include (i) resource utilization spikes, (ii) faults of the at least one node, (iii) failures of the at least one node, (iv) resource exhaustion, etc. The historical computing resource usage may include, for the at least one node, (i) central processing unit (CPU) utilization (e.g., an average CPU usage, a peak CPU usage, etc.), (ii) memory utilization (e.g., an average memory usage, a peak memory usage, etc.), etc. The historical computing resource consumption for operation of management frameworks may include (i) deployment frequency (e.g., a total number of deployments made in a period of time, etc.), (ii) resource allocation (e.g., an amount of CPU and/or memory allocated to the at least one server, the at least one node, etc.), (iii) an application response time (e.g., an average time taken by an application to respond to a request to perform a workload, etc.), etc.

The prediction regarding a future state of the deployment may be generated by ingesting the data package by the trained machine learning model and/or generating the future state of the deployment. The data package may be ingested by parsing, by the trained machine learning model, the information of the data package. The information of the data package may include the telemetry data and/or the historical workload metrics. The trained machine learning model may include (i) a neural network, (ii) a clustering model, (iii) a reinforcement learning model, (iv) a regression model, etc. The trained machine learning model may be trained by ingesting, by an untrained machine learning model (e.g., the neural network, the clustering model, the reinforcement learning model, the regression model, etc.), at least a portion of the information of the data package and/or generating at least one relationship. The future state may be generated, by the trained machine learning model, by identifying at least one association between the information of the data package and/or the at least one relationship to determine the future state of the deployment.

The at least one relationship may include (i) resource (e.g., CPU cores, memory, storage, etc.) consumption patterns by types of workloads, (ii) patterns and/or indicators of faults (i.e. errors and/or issues in the performance of the workload) and/or failures (i.e., a cessation of the performance of the workload due to a severe issue in the performance), (iii) identification of at least one relationship between performance metrics (e.g., latency, throughput, error rates, etc.), (iv) identification of a second at least one relationship between a workload and/or an affinity rule, etc. The affinity rule may define an arrangement of at least one container, assigned to perform the workload, in at least one node. The at least one node may include a virtualized computing unit that hosts and/or manages the at least one container.

The management operation may be selected by ingesting at least, by a scheduler, the future state and/or determining, by the scheduler, the management operation that improves an efficiency, reliability, etc. of the deployment. The future state may be ingested by parsing, by the scheduler, data included the future state. The data may include metrics that can be used by the scheduler to predict and/or optimize resource allocation and/or workload performance. The metrics may include (i) future workload demands, (ii) health status indicators of nodes, (iii) affinity rule preferences, (iv) cost projections, (v) potential anomaly indicators (e.g., at least one unusual pattern that indicates a potential for a fault and/or a failure), etc. The management operation may be generated by using the metrics to generate at least one management task of the management operation. The at least one management task may include (i) reallocating the resources (e.g., CPU cores, memory, disk storage, etc.) based on the future workload demands, (ii) selecting the nodes with healthy health statuses, (iii) enforcing the affinity rule preferences, (iv) remediating the at least one unusual pattern to prevent the fault and/or the failure from occurring, etc.

The management operation may be performed, by the scheduler, by performing the at least one management task. Because of the performance of the at least one management task, the continued completion of the workloads may be facilitated. Through the facilitation of the continued completion of the workloads, desired computer implemented services may be provided by the deployment.

To provide the above noted functionality, the system may include deployment 100, management system 104, and/or client system 106. Each of these components is discussed below.

Deployment 100 may include any number of data processing system 100A-100N. The any number of the data processing system 100A-100N may include hardware (CPU cores, memory, disk storage, etc.) and/or software by which a virtualized environment is hosted. The virtualized environment may include at least one virtual server. The at least one virtual server may include a measure of allocation of the hardware resources and/or may virtualize an operating system. In addition, the at least one virtual server may include at least one node. The at least one node may include a virtualized computing unit that hosts and/or manages the at least one container. The at least one container may include a deployable unit of software that includes an application and/or dependencies of the application.

The at least one container may be used by deployment 100 to perform a workload. The workload may be assigned to the at least one container by a scheduler of deployment 100. The scheduler may also distribute containers across the deployment based on (i) resource availability, (ii) the at least one affinity rule, (iii) a resource need of the workload, etc.

Management system 104 may interact with deployment 100. Management system 104 may interact with deployment 100 by (i) managing resources, (ii) deploying a workload, (iii) monitoring a state of deployment 100, etc. Further, management system 104 and/or at least one data processing system (e.g., 100A, etc.) may collect performance data of at least one workload from deployment 100. The performance data may include telemetry data and/or historical workload metrics of the deployment. Management system 104 and/or the at least one data processing system (e.g., 100A, etc.) may also preprocess the performance data and/or train an untrained machine learning model to generate a trained machine learning model. The trained machine learning model may be used, by management system 104 and/or the at least one data processing system (e.g., 100A, etc.), to predict a future state of deployment 100. The trained machine learning model and/or the untrained machine learning model may include (i) a neural network, (ii) a clustering model, (iii) a reinforcement learning model, (iv) a regression model, etc.

Client system 106 may also interact with deployment 100. For example, client system 106 may have access to at least one application on the at least one node through an application programming interface (API) endpoint. The access by client system 106 through an API endpoint may allow a client to, for example, (i) manage data, (ii) retrieve the data, (iii) update the data of the workload in the at least one application, (iv) receive at least one financial cost for at least one service performed by deployment 100, etc. Client system 106 may have access using, for example, a security token and/or a certificate for secure access. Also, client system 106 may communicate with the at least one node and/or the at least one virtual server to track a location and/or a progress of a workload performed by deployment 100.

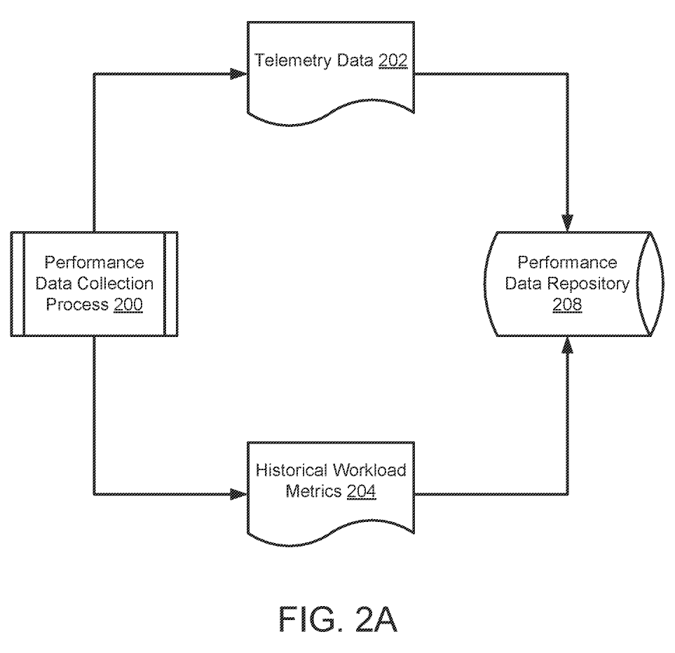

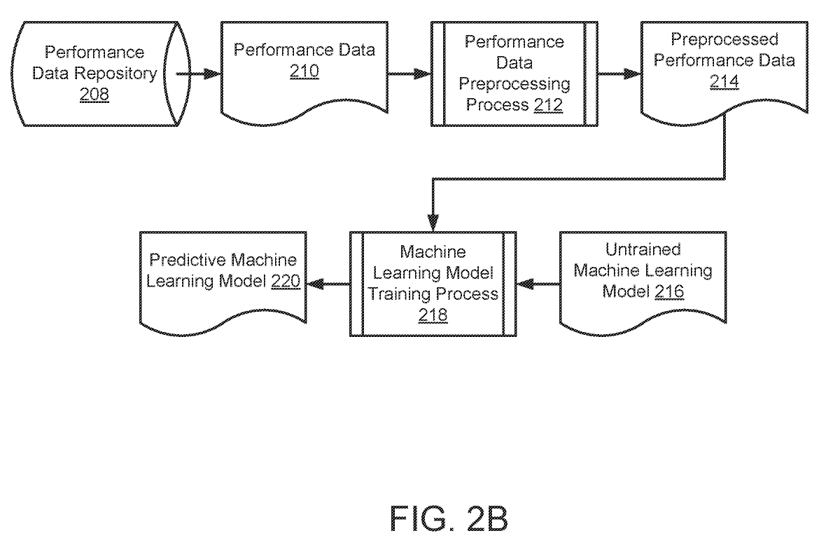

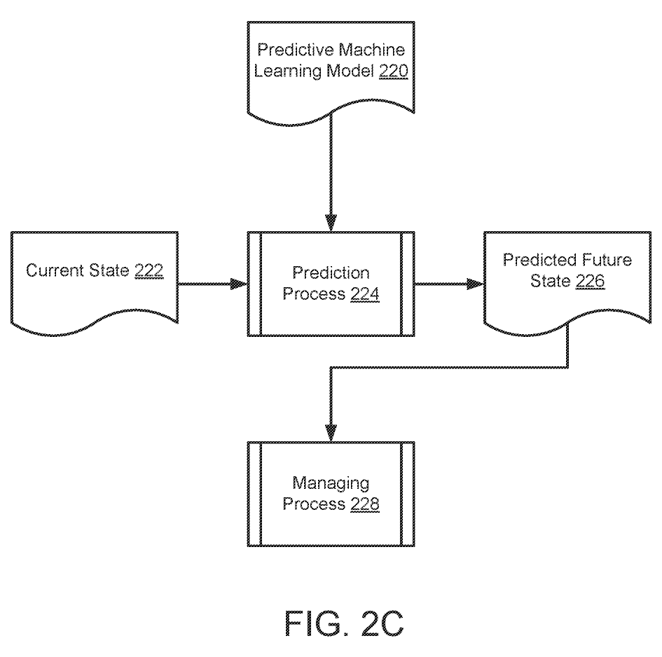

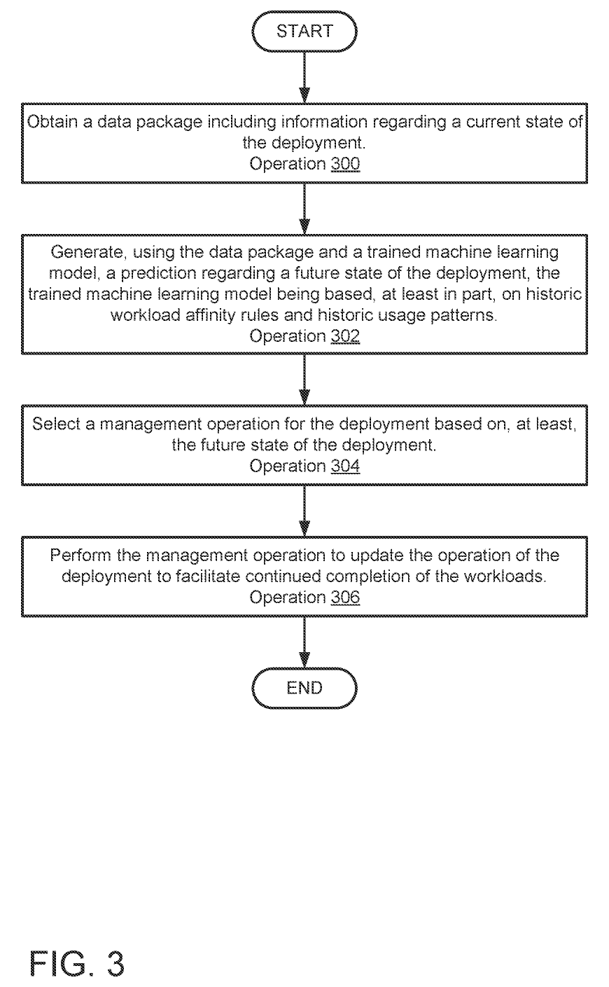

While providing their functionality, any of deployment 100, management system 104 and/or client system 106 may perform all, or a portion, of the flows and methods shown in FIGS. 2A-3.

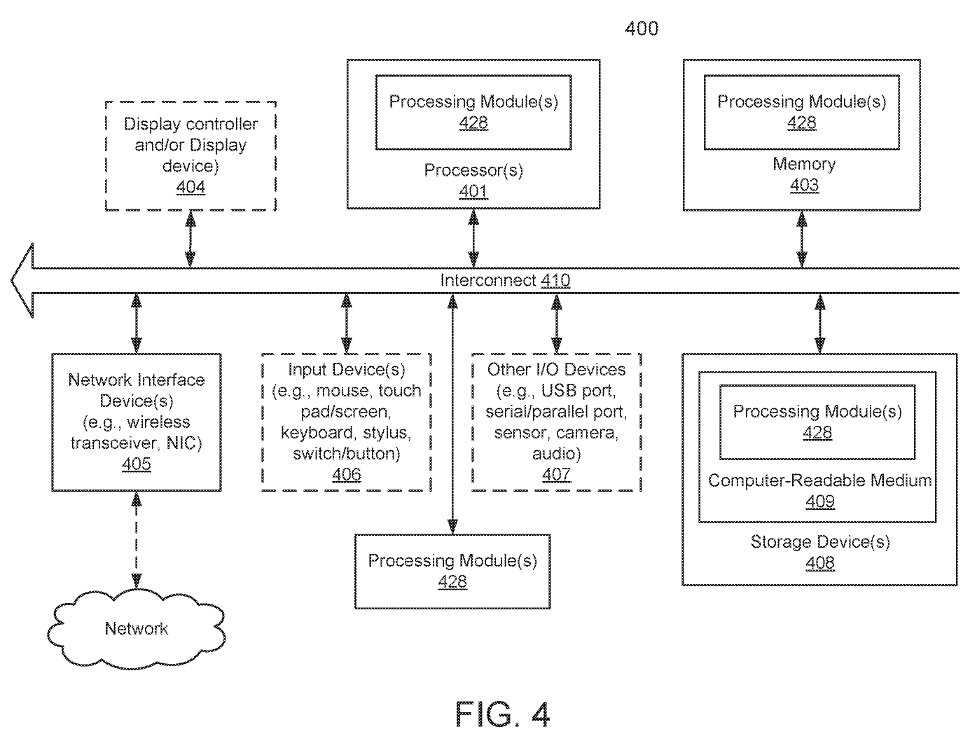

Any of (and/or components thereof) deployment 100, management system 104 and/or client system 106 may be implemented using a computing device (also referred to as a data processing system) such as a host or a server, a personal computer (e.g., desktops, laptops, and tablets), a "thin" client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the Internet protocol).

While illustrated in FIG. 1 as including a limited number of specific components, a system in accordance with an embodiment may include fewer, additional, and/or different components than those components illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 202, 204, etc.) is used to represent data structures, a second set of shapes (e.g., 200, 212, etc.) is used to represent processes performed using and/or that generate data, and a third set of shapes (e.g., 208, etc.) is used to represent large scale data structures such as databases.

Turning to FIG. 2A, a first data flow diagram in accordance with an embodiment is shown. The first data flow diagram may illustrate data used in and data processing performed in collecting performance data.

To collect the performance data, data collection process 200 may be performed. During data collection process 200, the performance data may be obtained from at least one component of the deployment (e.g., 100). The at least one component may include hardware and/or software of the deployment (e.g., 100). The hardware may include (i) redundant power supplies and/or uninterruptible power supplies, (ii) networking equipment (e.g., routers, network interface cards, etc.), (iii) cooling systems, etc. The software may include (i) a hypervisor of a virtualized environment, (ii) a management framework that deploys and/or manages containers in the virtualized environment, (iii) an operating system of at least one virtual server, (iv) at least one node of the at least one virtual server, (v) an application of the at least one node, etc.

The performance data may be obtained by monitoring a performance of the at least one component of the deployment (e.g., 100). The performance may be monitored using at least one monitoring tool. The at least one monitoring tool may (i) record metrics, (ii) generate logs, (iii) perform traces to understand a flow of at least one task in an operation, etc.

The performance data may include telemetry data (e.g., 202) and/or historical workload metrics (e.g., 204). The telemetry data (e.g., 202) may include (i) workload telemetry data for historical workloads performed by the deployment, (ii) device telemetry data for data processing systems of the deployment, (iii) cost telemetry data for cost incurred for use of the deployment by a user, etc. The workload telemetry data may include (i) resource consumption costs, (ii) time to completion of a workload, and/or (iii) workload requests for the historical workloads. The device telemetry data may include computing resource availabilities over time. The computing resource availabilities may include at least one current status and/or at least one measure of usage of central processing unit (CPU) cores, memory, network bandwidth, etc. The cost telemetry data may include financial costs for completion of the historical workloads. The financial costs may include charges related to a provision of services (e.g., computing instances, storage, data transfer, etc.) that are passed to a client (e.g., 106).

The historical workload metrics (e.g., 204) may include (i) historical performance metrics of the deployment, (ii) historical events impacting the deployment, (iii) historical computing resource usage by the deployment, (iv) historical computing resource consumption for operation of management frameworks (i.e. which facilitate the deployment of a container for performance of a workload) hosted by the deployment, etc. The historical performance metrics may include (i) disk input/output (I/O) (e.g., a number of read and/or write operation performed, I/O operations per second, etc.), (ii) network througₕput (e.g., an average bandwidth usage, a peak bandwidth usage, etc.), etc. The historical events may include (i) resource utilization spikes, (ii) faults of the at least one node, (iii) failures of the at least one node, (iv) resource exhaustion, etc. The historical computing resource usage may include, for the at least one node, (i) central processing unit (CPU) utilization (e.g., an average CPU usage, a peak CPU usage, etc.), (ii) memory utilization (e.g., an average memory usage, a peak memory usage, etc.), etc. The historical computing resource consumption for operation of management frameworks may include (i) deployment frequency (e.g., a total number of deployments made in a period of time, etc.), (ii) resource allocation (e.g., an amount of CPU and/or memory allocated to the at least one server, the at least one node, etc.), (iii) an application response time (e.g., an average time taken by an application to respond to a request to perform a workload, etc.), etc.

Once collected, the performance data may be stored in a performance data repository (e.g., 208). The performance data repository may be stored in a data processing system (e.g., 100A, 100B, etc.) of the deployment (e.g., 100), a management system (e.g., 104), etc. To store the performance data, the at least one monitoring tool may transmit the performance data in a data package (e.g., at least one network packet, etc.) through a communication protocol between the at least one node, the at least one virtual server, at least one data processing system (e.g., 100A, 100B, etc.), the management system (e.g., 104), etc.

Thus, via the first data flow illustrated in FIG. 2A, a system in accordance with an embodiment may collect the performance data. Consequently, the deployment (e.g., 100) may be more likely to be able to provide desired computer implemented services by obtaining at least one metric, at least one log, at least one flow of a task in an application, etc. of the at least one component of the deployment (e.g., 100).

Turning to FIG. 2B, a second data flow diagram in accordance with an embodiment is shown. The second data flow diagram may illustrate data used in and data processing performed in training a machine learning model to predict a future state of the deployment (e.g., 100).

To train the machine learning model to predict the future state of the deployment (e.g., 100), performance data preprocessing process 212 may be performed. During performance data preprocessing process 212, performance data (e.g., 210) may be obtained from a performance data repository (e.g., 208). The performance data (e.g., 210) may include telemetry data (e.g., 202) and/or historical workload metrics (e.g., 204), both of which are detailed in the description of FIG. 2A. Also, the performance data repository (e.g., 208) was also detailed in the description of FIG. 2A as well.

During performance data preprocessing process 212, preprocessed performance data (e.g., 214) may be generated. The preprocessed performance data (e.g., 214) may be generated by cleaning the performance data (e.g., 210). Cleaning the performance data (e.g., 210) may be performed by (i) correcting missing values, (ii) correcting data types (e.g., string, integers, floats, etc.) to ensure consistent data types in the performance data (e.g., 210), (iii) detecting outlying data of the in the performance data (e.g., 210) using a statistical method (e.g., Z-score analysis, Interquartile Range (IQR) method, boxplots, scatterplots, etc.) and/or removing the outlying data, (iv) normalizing and/or scaling a portion of data of the performance data (e.g., 210), etc.

After the preprocessed performance data (e.g., 214) has been generated, machine learning model training process 218 may be performed. During machine learning model training process 218, an untrained machine learning model (e.g., 216) may be obtained. The untrained machine learning model (e.g., 216) may include (i) a neural network, (ii) a clustering model, (iii) a reinforcement learning model, (iv) a regression model, etc. Parameters (e.g., weights, biases, etc.) of the untrained machine learning model (e.g., 216) may be initialized randomly and/or may not include fitting to the preprocessed performance data (e.g., 214). Because the untrained machine learning model (e.g., 216) may have not yet been fitted to the training data, the untrained machine learning model (e.g., 216) may not have learned any relationships and/or patterns of the preprocessed performance data (e.g., 214).

During machine learning model training process 218, a portion of the preprocessed performance data (e.g., 214) may be extracted as training data and/or the training data may be ingested by the untrained machine learning model (e.g., 216). The predictive machine learning model (e.g., 220) may be generated by determining, by the untrained machine learning model (e.g., 216), at least one relationship between a first portion of the training data and a second portion of the training data. The at least one relationship may include (i) resource (e.g., CPU cores, memory, storage, etc.) consumption patterns by types of workloads, (ii) patterns and/or indicators of faults (i.e. errors and/or issues in the performance of the workload) and/or failures (i.e., a cessation of the performance of the workload due to a severe issue in the performance), (iii) identification of at least one relationship between performance metrics (e.g., latency, throughput, error rates, etc.), (iv) identification of a second at least one relationship between a workload and/or an affinity rule, etc.

The predictive machine learning model (e.g., 220) may be a similar type of machine learning model as the untrained machine learning model (e.g., 216), which includes (i) the neural network, (ii) the clustering model, (iii) the reinforcement learning model, (iv) the regression model, etc. The parameters (e.g., weights, biases, etc.) of the predictive machine learning model (e.g., 220) may be fitted based on the at least one relationship. Therefore, upon ingestion, by the predictive machine learning model (e.g., 220), of, for example, a current state of the deployment (e.g., 100), the predictive machine learning model (e.g., 220) may generate, using the at least one relationship, a predicted future state of the deployment (e.g., 100).

The current state of the deployment may include (i) a current resource utilization (e.g., a current CPU usage by the at least one node, a current memory usage by the at least one node, etc.), (ii) at least one health status of the at least one node, (iii) a measure of performance for at least one application of the at least one node (e.g., response times, througₕput, etc.), (iv) a list of alerts, failures and/or faults of the at least one node, (v) the list of affinity rules, (vi) configuration settings (e.g., environment variables, resource limits, etc.), (vii) a current energy consumption by the at least one node of the deployment (e.g., 100), etc.

The predicted future state may include (i) a projection of resources needed by the at least one node for continuation of at least one workload by an application, (ii) a measure of the likelihood of the alerts, the failures and/or the faults for the at least one workload, (iii) the projection of how a load may be balanced across the at least one node, (iv) at least one recommendation for an addition and/or removal of the at least one node to continue performance of the at least one workload, (v) a future measure of health of (a) the at least one virtual server, (b) the at least one node, (c) at least one application, etc., (iv) a projected energy consumption by the at least one workload, etc.

Thus, via the second data flow diagram illustrated in FIG. 2B, a system in accordance with an embodiment may train the machine learning model to predict the future state of the deployment (e.g., 100). Consequently, the deployment (e.g., 100) may be more likely to be able to provide desired computer implemented services by leveraging the at least one relationship, learned by the machine learning model. of the performance data (e.g., 210) to predict a future state of the deployment (e.g., 100) based on the current state (which includes the performance of the at least one workload) of the deployment (e.g., 100).

Turning to FIG. 2C, a third data flow diagram in accordance with an embodiment is shown. The third data flow diagram may illustrate data used in and data processing performed in managing completion of a workload.

To manage the completion of the workload, prediction process 224 may be performed. During prediction process 224, a current state (e.g., 222) may be ingested by a predictive machine learning model (e.g., 220). The current state (e.g., 222) was detailed in the description of FIG. 2B. The predictive machine learning model (e.g., 220) was also detailed in the description of FIG. 2B.

During prediction process 224, the current state (e.g., 222) of the deployment (e.g., 100) may be ingested by the predictive machine learning model (e.g., 220) to generate the predicted future state (e.g., 226) of the deployment (e.g., 100). The current state (e.g., 222) may be ingested by (i) reading, by the predictive machine learning model (e.g., 220), the current state (e.g., 222) and/or (ii) using at least one relationship, learned by the predictive machine learning model (e.g., 220), of the current state (e.g., 222) to generate a predicted future state (e.g., 226).

The predicted future state (e.g., 226) may include (i) a projection of resources needed by the at least one node for continuation of at least one workload by an application, (ii) a measure of the likelihood of the alerts, the failures and/or the faults for the at least one workload, (iii) the projection of how a load may be balanced across the at least one node, (iv) at least one recommendation for an addition and/or removal of the at least one node to continue performance of the at least one workload, (v) a future measure of health of (a) the at least one virtual server, (b) the at least one node, (c) at least one application, etc., (iv) a projected energy consumption by the at least one task, etc.

The predicted future state (e.g., 226) may be ingested during managing process 228. During managing process 228, the predicted future state (e.g., 226) may be ingested by scheduler of the deployment (e.g., 100). The scheduler may determine, using the predicted future state (e.g., 226), a management operation that improves an efficiency and/or reliability of the deployment. The predicted future state (e.g., 226) may be ingested by parsing, by the scheduler, data included the predicted future state (e.g., 226). The management operation may be generated by using at least a portion of the predicted future state (e.g., 226) to generate at least one management task of the management operation. The at least one management task may include (i) reallocating the resources (e.g., CPU cores, memory, disk storage, etc.) to continue at least one task of at least one workload, (ii) selecting the at least one node with a healthy health status to continue the at least one workload, (iii) enforcing at least one affinity rule preferences listed in the predicted future state (e.g., 226), (iv) remediating at least one unusual pattern of the at least one task to prevent an occurrence of an alert, a fault and/or a failure, etc.

The management operation may be performed, by the scheduler, by performing the at least one management task. Because of the performance of the at least one management task, the completion of the at least one workload may be facilitated.

Thus, via the third data flow diagram illustrated in FIG. 2C, a system in accordance with an embodiment may manage the completion of the workload. Consequently, a deployment (e.g., 100) may be more likely to be able to provide desired computer implemented services by performing, by a scheduler, the management operation that includes the at least one management task. The at least one management task may optimize performance of the deployment (e.g., 100) based on the predicted future state (e.g., 226) of the deployment (e.g., 100), thereby facilitating the completion of the workload.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to manage operation of a deployment to facilitate completion of workloads. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the operation of the deployment to facilitate the completion of the workloads in accordance with an embodiment is shown. The method may be performed, for example, by any of the components of the system of FIG. 1, and/or other components not shown therein.

At operation 300, a data package that includes information regarding a current state of the deployment. The data package may be obtained by receiving, by a scheduler of the deployment, the data package. The data package may be transmitted to the scheduler from, for example, an administrator of the deployment, a monitoring tool, etc.

At operation 302, a prediction regarding a future state of the deployment may be generated using the data package and a trained machine learning model, the trained machine learning model being based, at least in part, on historic workload affinity rules and historic usage patterns. The prediction may be generated by (i) ingesting the data package, which includes the current state of the deployment, and/or (ii) determining at least one association between at least a portion of the data package and/or at least one relationship that has been learned by the trained machine learning model.

At operation 304, a management operation for the deployment, based on, at least, the future state of the deployment, may be selected. The management operation may be selected by ingesting at least, by the scheduler, the prediction and/or determining, by the scheduler and/or based on the prediction, the management operation that improves an efficiency, reliability, etc. of the deployment.

At operation 306, the management operation may be performed to update the operation of the deployment to facilitate continued completion of the workloads. The management operation may be performed by performing at least one management task of the management operation.

The method may end following operation 306.

Thus, via the method shown in FIG. 3, embodiments herein may likely improve a likelihood of managing the operation of the deployment to facilitate the completion of the workloads. By improving the likelihood of managing the operation of the deployment to facilitate the completion of the workloads, the deployment (e.g., 100) may be more likely to provide desirable computer implemented services by, for example, leveraging at least a current state of the deployment (e.g., 100) to predict a future state of the deployment (e.g., 100), performing an optimization of at least one component of the deployment (e.g., 100), based on at least the future state of the deployment (e.g., 100), to facilitate the completion of the workloads, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term "machine" or "system" shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface new acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term "computer-readable storage medium" should be taken to include a single medium or multiple media (e.g., a centralized or distributed database, and/or associated caches and servers) that store the one or more sets of instructions. The terms "computer-readable storage medium" shall also be taken to include any medium that is capable of storing or encoding a set of instructions for execution by the machine and that cause the machine to perform any one or more of the methodologies of embodiments disclosed herein. The term "computer-readable storage medium" shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine- readable (e.g., computer-readable) medium includes a machine (e.g., a computer) readable storage medium (e.g., read only memory ("ROM"), random access memory ("RAM"), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a deployment to facilitate completion of workloads, the method comprising:
obtaining a data package comprising information regarding a current state of the deployment;
generating, using the data package and a trained machine learning model, a prediction regarding a future state of the deployment, the trained machine learning model being based, at least in part, on historical workload affinity rules and historical usage patterns;
selecting a management operation for the deployment based on, at least, the future state of the deployment; and
performing the management operation to update the operation of the deployment to facilitate continued completion of the workloads.

2. The method of claim 1, wherein the information comprises:
workload telemetry data for historical workloads performed by the deployment;
device telemetry data for data processing systems of the deployment; and
cost telemetry data for cost incurred for use of the deployment by a user.

3. The method of claim 2, wherein the workload telemetry data indicates resource consumption costs, time to completion, and workload requests for the historical workloads.

4. The method of claim 3, wherein the cost telemetry data indicates financial cost for completion of the historical workloads.

5. The method of claim 2, wherein the device telemetry data indicates, for the data processing systems, computing resource availabilities over time.

6. The method of claim 1, wherein the management operation is one selected from a list of management operations consisting of:
scheduling of performance of a new workload by a portion of the deployment;
reallocating resources of the deployment ahead of a resource limiting event that is predicted to impact the deployment; and
migrating an existing workload hosted by the first portion of the deployment to a second portion of the deployment.

7. The method of claim 1, wherein the trained machine learning model is also based on, at least in part, historical performance metrics of the operation of the deployment, historical events impacting the deployment, and historical computing resource usage by the deployment.

8. The method of claim 7, wherein the trained machine learning model is based on a training data set comprising the historical performance metrics of operation of the deployment, the historical events impacting the deployment, the historical computing resource usage by the deployment, historical workload affinity rules, and historical usage patterns.

9. The method of claim 8, wherein the training data set further comprises historical computing resource consumption for operation of management frameworks hosted by the deployment, the management frameworks facilitate deployment and operation of containerized workloads.

10. The method of claim 9, wherein the deployment comprises data processing systems that host instances of the management frameworks, the management frameworks being adapted to deploy and manage operation of containers that perform the containerized workloads.

11. A non-transitory machine-readable medium having instructions stored therein, which when executed by a processor, cause the processor to perform operations for managing operation of a deployment to facilitate completion of workloads, the operations comprising:
obtaining a data package comprising information regarding a current state of the deployment;
generating, using the data package and a trained machine learning model, a prediction regarding a future state of the deployment, the trained machine learning model being based, at least in part, on historical workload affinity rules and historical usage patterns;
selecting a management operation for the deployment based on, at least, the future state of the deployment; and
performing the management operation to update the operation of the deployment to facilitate continued completion of the workloads.

12. The non-transitory machine-readable medium of claim 11, wherein the information comprises:
workload telemetry data for historical workloads performed by the deployment;
device telemetry data for data processing systems of the deployment; and
cost telemetry data for cost incurred for use of the deployment by a user.

13. The non-transitory machine-readable medium of claim 12, wherein the workload telemetry data indicates resource consumption costs, time to completion, and workload requests for the historical workloads.

14. The non-transitory machine-readable medium of claim 13, wherein the cost telemetry data indicates financial cost for completion of the historical workloads.

15. The non-transitory machine-readable medium of claim 12, wherein the device telemetry data indicates, for the data processing systems, computing resource availabilities over time.

16. A data processing system, comprising:
a processor; and
a memory coupled to the processor to store instructions, which when executed by the processor, cause the processor to perform operations managing operation of a deployment to facilitate completion of workloads, the operations comprising:
obtaining a data package comprising information regarding a current state of the deployment;
generating, using the data package and a trained machine learning model, a prediction regarding a future state of the deployment, the trained machine learning model being based, at least in part, on historical workload affinity rules and historical usage patterns;
selecting a management operation for the deployment based on, at least, the future state of the deployment; and
performing the management operation to update the operation of the deployment to facilitate continued completion of the workloads.

17. The data processing system of claim 16, wherein the information comprises:
workload telemetry data for historical workloads performed by the deployment;
device telemetry data for data processing systems of the deployment; and
cost telemetry data for cost incurred for use of the deployment by a user.

18. The data processing system of claim 17, wherein the workload telemetry data indicates resource consumption costs, time to completion, and workload requests for the historical workloads.

19. The data processing system of claim 18, wherein the cost telemetry data indicates financial cost for completion of the historical workloads.

20. The data processing system of claim 17, wherein the device telemetry data indicates, for the data processing systems, computing resource availabilities over time.
